(19) United States
(12) Patent Application Publication
(10) Pub. No.: US 2016/0156946 A1
(43) Pub. Date: Jun. 2, 2016

(54) METHOD, APPARATUS AND SYSTEM FOR COVERT ADVERTISING

(71) Applicants: Yuntao SHI, Beijing (CN); Zhigang ZHANG, Beijing (CN); Yanfeng ZHANG, Beijing (CN)

(72) Inventors: Yuntao SHI, Beijing (CN); Zhigang ZHANG, Beijing (CN); Yanfeng ZHANG, Beijing (CN)

(73) Assignee: THOMSON LICENSING, Issy les Moulineax (FR)

(21) Appl. No.: 14/907,141

(22) PCT Filed: Jul. 24, 2013
(86) PCT No.: PCT/CN2013/079951

§ 371 Date: Jan. 22, 2016

(51) Int. Cl. H04N 21/234; H04N 21/854; H04N 21/488; H04N 21/81; H04N 21/61

(52) U.S. Cl. CPC H04N 21/23424; H04N 21/812; H04N 21/6125; H04N 21/4888; H04N 21/85406

(57) ABSTRACT

A covert advertising method, apparatus and system are provided. The method, apparatus and system include converting at least one of audio, a visual product representation and a visual service representation in video content into text, searching a database to determine if an identifier for stored advertising content is associated with the text and if an identifier for stored advertising content is associated with the text, requesting the communication of the associated stored advertising content for display.

### BACKGROUND OF THE INVENTION

1. Technical Field

The present principles relate to the delivery of advertising content and more particularly to a method, apparatus and system for the delivery and presentation of video content and respective covert advertising content.

2. Related Art

Covert advertising, also known as embedded advertising, is the inclusion of promotional messages such as a product or brand inside another media or program. Normally, the covert advertising is designed into the original program. Sometimes, it can be added at a later time, or merged into the display area. The embedded advertising is a form of advertising in media (not limited to the video), but it works under the premise that is a natural part of the media content, not in the usual more direct manner to tell the viewer that it is an advertisement.

Although it is not a direct way to advertise something, it also makes for an efficient way to deliver advertising content. There has been an increasing trend of covert advertising in TV shows and in film to advertise products and services. Many companies now pay film producers to have their products featured in media content (such as film, TV shows). The content producers like to use covert advertising to save on budgets and reduce financial risks in the production. Compared to the traditional overt advertising, covert advertising means that the advertisement is being integrated into a program. Covert advertising involves various types of advertising and often includes product logos, products referenced by the actors, and product placement in the scene. Some examples include: billboards of products shown in a film; a character in a TV show or film mentioning the name of the brand again and again; and/or a character in a TV shown holding or actually using a product.

The challenge for covert advertising is how to make the advertisement stand out well and be noticed by those watching the media content. Firstly, the covert advertising can be displayed only a few seconds and the advertising should be seen without interrupting the media content. Secondly, the content of covert advertising is not rich enough due to the limited presentation modes such as only being referenced by actor's lines.

US Patent Publication No. US2009/0199235 entitled “Video contextual advertisements using speech recognition” teaches the selection of an advertisement based on the speech recognition data indicative of an audio portion of the video clip. Using speech recognition technology during video playing will face challenges in noisy environments, such as gym, restaurants, a café, or even at home.

### SUMMARY OF THE INVENTION

Embodiments of the present invention address the deficiencies of the prior art by providing a method, apparatus and system for covert advertising.

In one embodiment of the present invention, a method for covert advertising includes converting at least one of audio, a visual product representation and a visual service representation in video content into text, searching a database to determine if an identifier for stored advertising content is associated with the text, and if an identifier for stored advertising content is associated with the text, requesting the communication of the associated stored advertising content for display. The method can further include delivering the associated stored advertising content for display and displaying the associated stored advertising on a display.

In an alternate embodiment of the present invention, an apparatus for covert advertising includes a lines manager for converting at least one of audio, a visual product representation and a visual service representation in video content into text and an advertisement manager for searching a database to determine if an identifier for stored advertising content is associated with the text and if an identifier for stored advertising content is associated with the text, requesting the communication of the associated stored advertising content for display.

In an alternate embodiment of the present invention, a system for covert advertising includes a content provider for providing video content including advertising content, a display for displaying video content, a database for storing advertising content and an apparatus for covert advertising, the apparatus including a lines manager for converting at least one of audio, a visual product representation and a visual service representation in video content into text and an advertisement manager for searching the database to determine if an identifier for stored advertising content is associated with the text and if an identifier for stored advertising content is associated with the text, requesting the communication of the associated stored advertising content for display. The system can further include a communications service for communicating the associated stored advertising content for display on the display.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a system for covert advertising in accordance with an embodiment of the present invention;

FIG. 2 depicts an exemplary table structure of the advertisement database in accordance with an embodiment of the present invention;

FIG. 3 depicts a flow diagram of a method for covert advertising in accordance with an embodiment of the present invention;

FIG. 4 depicts a high level block diagram of a system for covert advertising in accordance with an alternate embodiment of the present invention; and

FIG. 5 depicts a high level block diagram of an apparatus for covert advertising in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

Embodiments of the present invention advantageously provide a method, apparatus and system for covert advertising. Although the present invention will be described primarily within the context of covert advertising in video content being presented on a television display, the specific embodiments of the present invention should not be treated as limiting the scope of the invention. It will be appreciated by those skilled in the art and informed by the teachings of the present invention that the concepts of the present invention can be advantageously applied to any content presented on any display.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

Furthermore, because some of the constituent system components and methods depicted in the accompanying drawings can be implemented in software, the actual connections between the system components or the process function blocks may differ depending upon the manner in which the present principles are programmed. Given the teachings herein, one of ordinary skill in the pertinent art will be able to contemplate these and similar implementations or configurations of the present principles.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It should be noted that in the description herein, covert advertising content, covert advertisement, advertising content and the like are interchangeable and refer to advertising content or advertisements intended to be displayed relative to a product or service that is to be advertised. It should also be noted the in the description herein, video content should be interpreted to encompass any content containing at least a video component such as audiovisual content and the like, from any source.

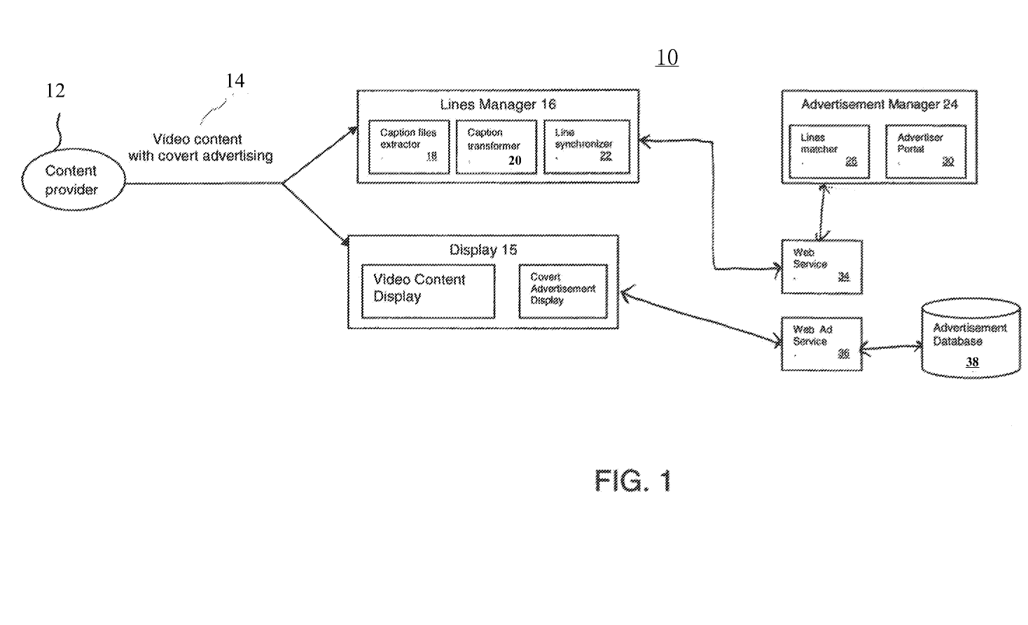

FIG. 1 depicts a high level block diagram of a system for covert advertising in accordance with an embodiment of the present invention. The system 10 of FIG. 1 illustratively comprises a content provider 12, an advertiser 13, video content including covert advertising 14 and a lines manager 16 including a caption files extractor 18, a caption transformer 20 and a lines synchronizer 22. The system 10 of FIG. 1 further illustratively comprises an advertisement manager 24 including a service 34 (illustratively a web service), an ad service 36 (illustratively a web ad service), an advertisement database 38, and a covert advertisement manager 26. The covert advertisement manager 26 of FIG. 1 illustratively comprises a lines matcher 28, and an advertising portal 30. In the embodiment of the system 10 of FIG. 1, a content provider 12 owns the video content 14 which can include covert advertising embedded therein. The video content 14 can be played on the client side through, for example, the Internet (e.g., NETFLIX® or any other streaming video service), broadcast TV or other broadcast service, DVD or any other content delivery mechanism. In any event, the end user or client side can display and view the streamed video content. Although in the embodiment of FIG. 1, the video content 14 is illustratively bifurcated to the display 15 and the lines manager 16, in alternate embodiments of the present invention, the lines manager 16 can get the video stream from the display 16.

In accordance with embodiments of the present invention, audio, such as dialogue in the video content, and visual product or service representations, such as billboard ads or brand names on products presented in video content or ads for services, are converted into text. For example, in one embodiment of the present invention, video content including covert advertising 14 is provided to a lines manager such as the lines manager 16 of FIG. 1. The lines manager of the present invention converts the audio and visual representation of brands into text by, in one embodiment of the present invention, retrieving such text information from Internet sources or from the content provider 12 or the advertiser 13. In an alternate embodiment of the present invention described in more detail below, the lines manager 16 converts the audio and visual representations of brands in the video content to text by using closed captioning information included with the video content or closed captioning information procured from an alternate source such as the Internet. In such embodiments of the present invention, the caption files extractor 18 extracts such information from the video content and the caption transformer 20 converts the different kinds of caption formats to text (described in greater detail below).

Referring back to FIG. 1, the converted text is communicated to the covert advertising manager 26, which searches the covert advertisement database 38 to determine if an identifier for stored advertising content is associated with the text. For example, in one embodiment of the present invention, the lines matcher 28 of the advertising manager 26 receives a request via the communication service 34, which can receive a lines matching request from the client side via, for example the lines manager 16, and implement the Lines matcher 28 to search the advertisement database 38 to determine if an identifier for stored advertising content is associated with text in the video content. In the embodiment of FIG. 1, the communication service 34 is illustratively depicted as a web service, however in alternate embodiments of the present invention, other communication services can be implemented.

That is, in an embodiment of the present invention, covert advertisements are stored in the advertisement database 38 using identifiers which relate to or are associated with text in the video content that identifies product(s) or services for which respective stored advertisements are intended to advertise. For example, in one embodiment of the present invention, a text string can be used to identify a respective stored advertisement such that when the text string is identified as having been played/executed in the video content, the stored advertisement can be communicated for display at a client site for example on a designated portion of a video device on which the video content is being displayed or in alternate embodiments of the present invention, on an alternate screen or display device such as a tablet or mobile communication device either concurrently with or at some time relative to the display of respective video content on a main display. That is, if an identifier for stored advertising content is representative of text associated with content in the video content having been played, the communication of the associated stored advertising content is requested for display. More specifically, the web service 36 delivers covert advertisement to a display, for example the video display 15 on the client side of FIG. 1. For example and in the embodiment of FIG. 1, a covert advertisement is displayed on a portion of the main display 15. As depicted in the embodiment of FIG. 1, the web service 36 is in communication with the advertisement database 38.

In embodiments of the present invention, such as the embodiment of FIG. 1, the Advertiser portal 30 of the advertisement manager 24 enables advertisers 13 to manage the related covert advertising for specific video content. In one embodiment of the present invention, the Advertiser portal 30 can be a web portal based on the HTML version compliant with most browsers. Using the Advertiser portal 30, an advertiser 13 can locate lines or text in the video content with covert advertising value and modify, remove or append related covert advertising indexed by the lines in the video.

In embodiments of the present invention, a lines synchronizer, such as the line synchronizer 22 of FIG. 1, is implemented to procure timing information for the text of the video content. That is, the line synchronizer of the present invention is implemented to determine where in the video content the audio and visual product or service representations in the video content, now converted into text, occurred. Such information is used in embodiments of the present invention in which it is desirable to communicate for display covert advertisements associated with the converted text concurrent with or at a relative point to the audio and visual product or service representations in the video content represented by the text.

As described above, embodiments of the present invention take advantage of the closed caption functionality of video content. That is, captions in video content are either open or closed. Closed caption is an added value to the video content and is optional, to be viewed usually by request of an end viewer/user. Open caption is an integral part of the video content and is difficult to extract from a video frame. There are many different kinds of caption file formats to support captioning for broadcasts, DVDs, web media players and video-sharing sites. For example, a commonly used caption file format is SRT; SAMI (Synchronized Accessible Media Interchange) or SMI captions for Windows Media video or audio. Other caption formats include PAL time-code version of DVD subtitles for DVD Studio Pro, SBV captions format that stands for Subviewer for YouTube, SML format to instruct a QuickTime player how to play the QuickTime text track captions with the QuickTime video or audio, and bbtv format for HDTV. The video content provider can provide caption files and, in addition, some professional websites also provide caption file services. End users/viewers can also make and upload captions files themselves. In alternate embodiments of the present invention, line by line text information can be provided to a system of the present invention.

In one embodiment of the present invention, on an end user's/viewer's side, the lines manager 16 is maintained and executed via the user's computer system or tablet or set-top box or other computing device capable of streaming video and having processing and memory capabilities. In such an embodiment and as depicted in FIG. 1, the lines manager 16 includes the caption files extractor 18, the caption transformer 20 and the lines synchronizer 22. In one embodiment of the system 10 of FIG. 1, when a video is playing, the caption files extractor 18 analyzes video files in real time and produces independent captions files from the closed captions data. In an alternate embodiment of the present invention, if the video does not have caption data, the caption files extractor 18 obtains the caption file by accessing a website which provides the caption data for the video content. As previously described, there are many kinds of caption formats such as .SRT, .XML, .SML, SBV (i.e., captions from YouTube), etc. The caption transformer 20 of the system 10 of FIG. 1 converts the different kinds of formats to text and in one embodiment into a line by line text format. This conversion provides a uniform interface for the Lines synchronizer 22 and lines matching. By way of example, in one embodiment of the present invention, the final caption text format contains the information listed below.
<line number> <start time> <end time>
<line number> <lines>
   This caption file contains the text and the timing information of the video. For example, in one embodiment of the present invention, the caption file can comprise the following format:
1. 00:00:02:01 00:00:05:50
2. Hello, today I'm going to Disney.
3. 00:00:05:50 00:00:09:50
4. This car is so cool.

In one embodiment of the present invention, the lines synchronizer 22 accesses the interface of a media player, and can periodically “snoop” the state of the player to obtain the timestamp of video being displayed. The lines synchronizer 22 can then use the obtained timestamp to match the text or lines of text of the caption file to the video content. In one embodiment of the present invention, when the media player is stopped, the lines synchronizer 22 stops snooping until the media player resumes playing.

As depicted in the system 10 of FIG. 1, the advertisement manager 24 includes two web service interfaces 34 and 36 on the client's side. In the system 10 of FIG. 1, one web service 34 interfaces with the lines matcher 28, and the other web service 36 is for delivery of covert advertisement to the client and is in communication with the advertisement database 38 which stores at least the covert advertising data. The advertisement manager 24 further includes covert advertising manager 26, which includes Lines matcher 28 and Advertiser portal 30. The Advertiser portal 30 of the advertisement manager 24 enables advertisers 13 to manage the related covert advertising for specific video content. In one embodiment of the present invention, the Advertiser portal 30 can be web portal based on the HTML version compliant with most of browsers. Using the Advertiser portal 30, an advertiser 13 can locate lines or text in the video content with covert advertising value and modify, remove or append related covert advertising indexed by the lines in the video. For example, the web service 34 can receive a lines matching request from the client side, and implement the Lines matcher 28 to match lines of text with relevant advertising in the advertisement database 38. In accordance with embodiments of the present invention, any database query algorithm can be used to find the relevant advertising in the advertisement database 38. Subsequently, once the relevant advertising is located, the Ad service 36 can deliver the matched advertisement to the client. That is, the Ad service 36 can deliver the matched Ads (Ad1, Ad2, Ad3, etc.) to a user's display device 15. Although in the embodiment of FIG. 1, the Ad service 36 is depicted as a web ad service, it will be appreciated by those skilled in the art that in alternate embodiments of the present invention, alternate communication services can be implemented.

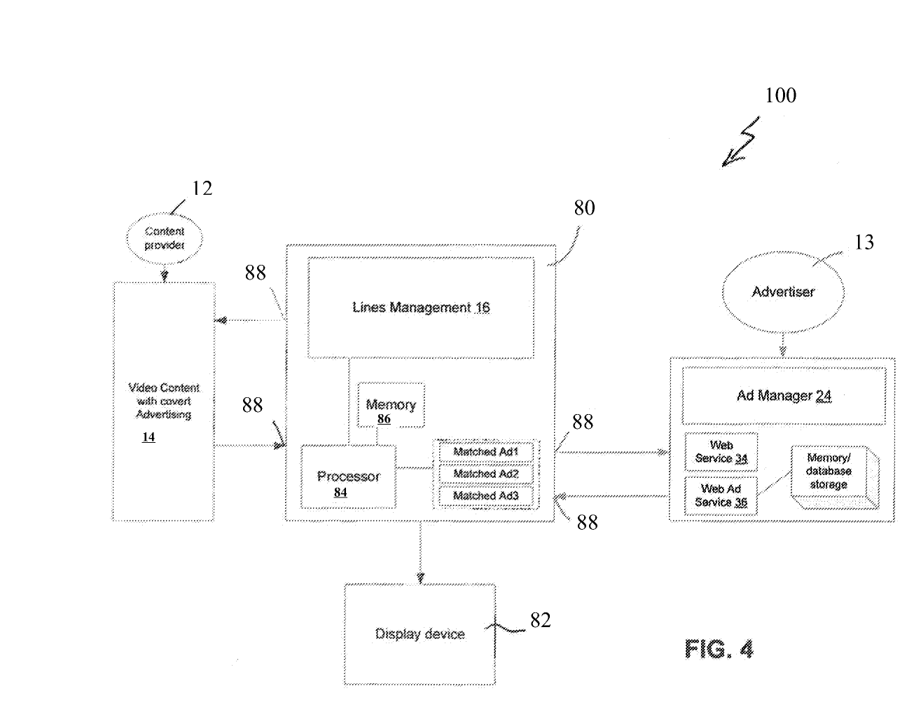

Although in the system 10 of FIG. 1, the various components are depicted as separate components, and in some instances separate components in different locations (i.e., the lines manager 16 on a client side and the advertisement manager 24 on a server side) in alternate embodiments of the present invention some, all or any combination of the various illustrated components can be integrated into one or various components. For example, in one embodiment of the present invention, the lines manager 16 and the advertisement manager 24 can be resident in a computer platform and which will not only include processing capability along with corresponding memory storage functions, but also communication protocols and interfaces supporting secure wired and/or wireless communications. Examples of these interfaces 88 and communication protocols are depicted in FIG. 4 and can include Ethernet, WiFi which can include 802.11b and 802.11g wireless protocols, cellular connections, etc. Those of skill in the art will appreciate that these connections, interfaces and communication protocols can be changed or modified without departing from the intended scope of the present invention. In alternate embodiments of the present invention, the components of the present invention can be integrated into a set-top box or other video content player.

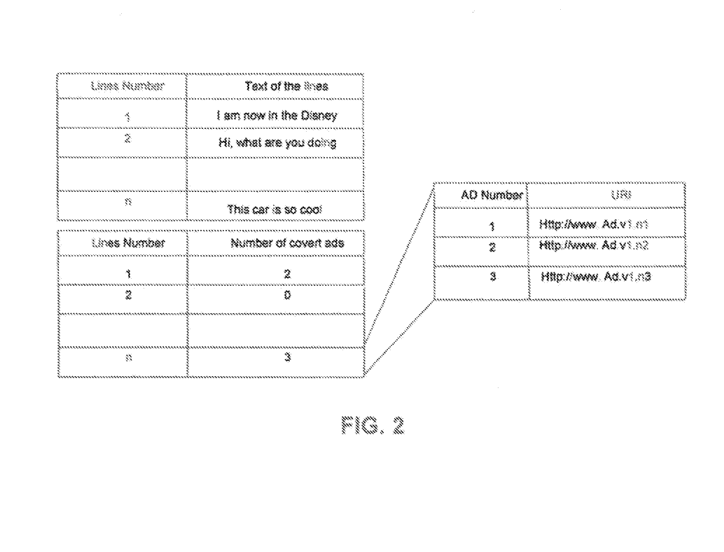

FIG. 2 depicts an exemplary table structure of the advertisement database in accordance with an embodiment of the present invention. In the embodiment of FIG. 2, unique line numbers are assigned to lines of text of the video content. The unique line numbers representing the lines of text are then correlated with a number of covert advertisements associated with a specific line of text. For example, in the embodiment of FIG. 2, the line number n representing the line of text “This car is so cool” is correlated with three (3) covert advertisements stored in the database. As depicted in the embodiment of FIG. 2, each covert advertisement is assigned a respective Uniform Resource Identifier (URI). In the embodiment of FIG. 2, after a line of text is associated with a respective covert advertisement(s), the respective covert advertisement can then be communicated for display upon a request for covert advertisement using the associated text as described above. As previously described, the related covert advertising content from the Advertisement database 38 can be displayed on a portion of a client display. In alternate embodiments of the present invention, the related advertising content can also be communicated for display on another device like a tablet, iPAD or Smartphone or on a predefined area of a web page thereon (not shown).

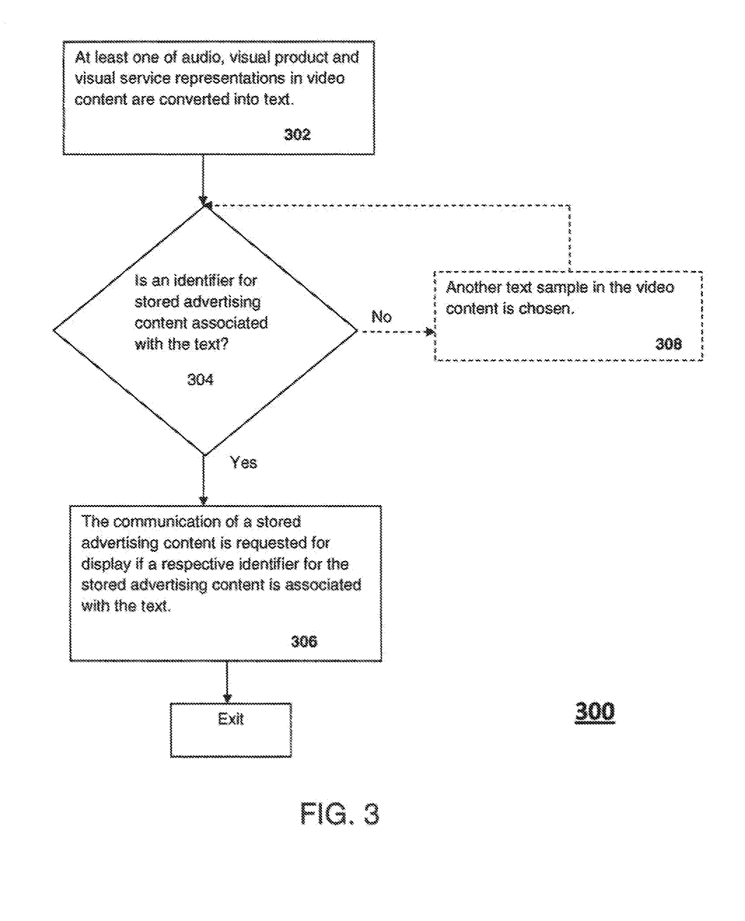

FIG. 3 depicts a flow diagram of a method for covert advertising in accordance with an embodiment of the present invention. The method 300 begins at step 302 during which at least one of audio, such as actor's dialog, and visual product or service representations, such as branded products or services, in video content are converted into text. For example, in one embodiment of the present invention, the captions file extractor 18 produces independent captions files from closed caption data in a video stream of video being displayed on a display device, for example, the web media player on the Internet. If there is no caption data in the video stream, the captions file extractor 18 accesses a previously identified website to obtain the caption data. The captions file extractor 18 then produces independent captions files from the obtained closed caption data. After the caption file is obtained, the lines transformer converts the caption file to a line by line text format. The method 300 then proceeds to step 304.

At step 304, an advertisement database, such as the advertisement database 38 of FIG. 1, is searched to determine if an identifier for stored covert advertising content is associated with text in the video content. For example, in one embodiment of the present invention, covert advertising content is stored using an identifier that is associated with a respective text or line of text in the video content such that the covert advertising content identified and stored using the identifier associated with the text or line of text is selected for delivery to a means of display. In one embodiment of the present invention, the selected covert advertisement is communicated for display when the respective text or line of text in the video content is played. If text in video content is associated with an identifier of stored covert advertising, the method 300 proceeds to step 306. If text in the video content is not associated with an identifier for stored covert advertising, the method 300 can optionally proceed to step 308. It should be noted that in accordance with embodiments of the present invention, more than one covert advertisement can be associated with specific text or a line of text.

At step 306, a request is made to communicate the associated/selected covert advertising content for display. For example, in one embodiment of the present invention, a request is communicated by the covert advertisement manager 26 to the Ad server 36 to communicate the respective covert advertising to a client side for display. In one embodiment of the present invention, the covert advertising is displayed on a predefined area of the display being used to display the original video content. In alternate embodiments of the present invention, the covert advertising can be displayed on an alternate display such as a tablet, computer or mobile communications device or other display device. The method 300 can then be exited.

At optional step 308, another text sample or line of text in the video content is chosen. The method then returns to step 304. If no associated identifier exists for the next text or line of text in the video content, step 308 is repeated. If no further text or lines of text exist, the method 300 can be exited.

In an alternate embodiment of the present invention, a method of the present invention, such as the method 300, can further include associating a time stamp with determined lines of text of the video content. For example, in one embodiment of the present invention, the lines synchronizer 22 accesses a media player interface to obtain time stamp information for lines of text of the video content. As such, lines of text are synchronized with video playing. In such an embodiment, covert advertisement(s) associated with text or lines of text can be communicated for display concurrent with or some time relative to the playing of the text or line of text in the video content.

FIG. 4 depicts a high level block diagram of a system for covert advertising in accordance with an alternate embodiment of the present invention. The above embodiment of FIG. 1 operates under the principle that the lines management module 16 is part of a user's computer system. In the embodiment of FIG. 4, a set top box 80 replaces the user's computer and includes a processor 84 and a memory 86 and a lines management module 16. In the embodiment of FIG. 4, a display device 82 is connected to the set top box 80 via any suitable known connection (e.g., HDMI). The lines management module 16 in conjunction with the processor 84 delivers the matched Ads (Ad1, Ad2, Ad3, etc.) to a user's attached display device 82 as described above in the embodiment of FIG. 1.

With a set-top-box implementation as in the embodiment of FIG. 4, the system and method of covert advertising delivery of the present invention is not limited to video playing on the Internet. As such, the same can be implemented for live broadcasting (e.g., news, sports . . . ), DVD, film and any textual types of media which have potential advertising values for a content provider and advertiser.

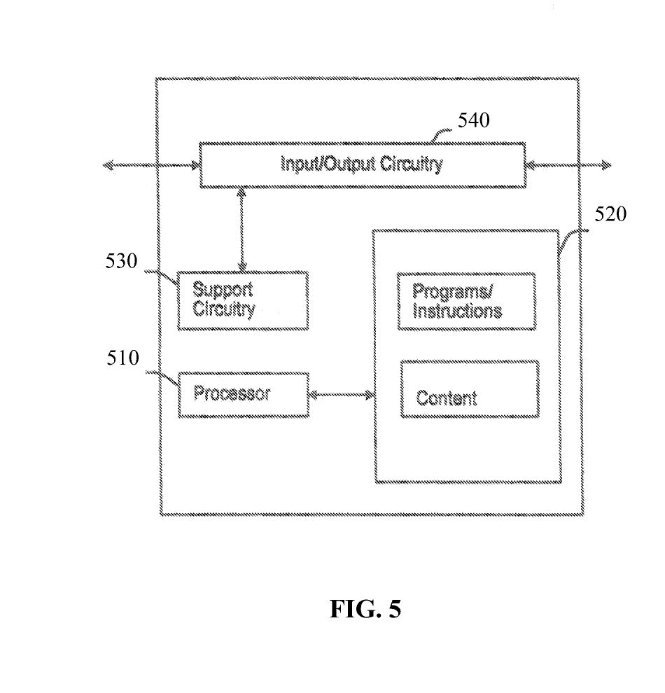

FIG. 5 depicts a high level block diagram of an apparatus for covert advertising in accordance with an embodiment of the present invention. More specifically, FIG. 5 depicts an alternate embodiment of the covert advertising apparatus of FIG. 1 in which the functionalities of at least some of the various components depicted in FIG. 1 are performed using applications or software implementations. The covert advertising apparatus of FIG. 5 comprises a processor 510 as well as a memory 520 for storing control programs, instructions, software, video content, advertising content and the like. The processor 510 cooperates with conventional support circuitry 530 such as power supplies, clock circuits, cache memory and the like as well as circuits that assist in executing the software routines stored in the memory 520. As such, it is contemplated that some of the process steps discussed herein as software processes may be implemented within hardware, for example, as circuitry that cooperates with the processor 510 to perform various steps. The covert advertising apparatus also contains input-output circuitry 540 that forms an interface between the various respective functional elements communicating with the covert advertising apparatus.

Although the covert advertising apparatus of FIG. 5 is depicted as a general purpose computer that is programmed to perform various control functions in accordance with the present invention, the invention can be implemented in hardware, for example, as an application specified integrated circuit (ASIC). As such, the process steps described herein are intended to be broadly interpreted as being equivalently performed by software, hardware, or a combination thereof.

Having described various embodiments of a method, apparatus and system for covert advertising (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention. While the forgoing is directed to various embodiments of the present invention, other and further embodiments of the invention may be devised without departing from the basic scope thereof.

1. A method for delivering advertising comprising the steps of:
converting at least one of audio, a visual product representation and a visual service representation in video content into text;
searching a database to determine if an identifier for stored advertising content is associated with the text; and
if an identifier for stored advertising content is associated with the text, requesting the communication of the associated stored advertising content for display.

2. The method of claim 1, comprising obtaining time stamp information for the text.

3. The method of claim 2, comprising requesting the communication of the associated stored advertising content for display at a time concurrent with or relative to a display of at least one of respective audio, a respective visual product representation and a respective visual service representation in the video content.

4. The method of claim 2, wherein the time stamp information is obtained from a video player playing the video content

5. The method of claim 2, wherein the database is searched for text at a time at least one of respective audio, a respective visual product representation and a respective visual service representation associated with the text is presented in the video content.

6. The method of claim 1, comprising:
if an identifier for stored advertising content is not associated with text related to specific audio or product or service representations in the video content, searching a database to determine if an identifier for stored advertising content is associated with text related to other audio or product or service representations in the video content.

7. The method of claim 1, comprising using closed captioning information to convert audio or product or service representations in the video content into text.

8. The method of claim 7, comprising obtaining said closed captioning information from an Internet source.

9. The method of claim 7, wherein said closed captioning information is included in the video content.

10. The method of claim 1, wherein said text comprises a line by line text format.

11. An apparatus for covert advertising comprising:
a lines manager for converting at least one of audio, a visual product representation and a visual service representation in video content into text; and
an advertisement manager for searching a database to determine if an identifier for stored advertising content is associated with the text and if an identifier for stored advertising content is associated with the text, requesting the communication of the associated stored advertising content for display.

12. The apparatus of claim 11, comprising a caption files extractor for extracting caption information from the video content.

13. The apparatus of claim 12, comprising a caption transformer for converting different kinds of caption formats to text.

14. The apparatus of claim 11, comprising a line synchronizer for procuring timing information for the text of the video content.

15. The apparatus of claim 11, wherein said advertisement manager comprises a lines matcher for determining if an identifier for stored advertising content is associated with the text.

16. The apparatus of claim 11, comprising an advertising portal for enabling an advertiser to manipulate and control advertising content.

17. The apparatus of claim 11, comprising a database for storing advertising content.

18. A system for covert advertising, comprising:
a content provider for providing video content including covert advertising content;
a display for displaying at least video content;
a database for storing covert advertising content;
an apparatus comprising:
a lines manager for converting at least one of audio, a visual product representation and a visual service representation in video content into text; and
an advertisement manager for searching the database to determine if an identifier for stored covert advertising content is associated with the text and if an identifier for stored covert advertising content is associated with the text, requesting the communication of the associated stored covert advertising content for display;
and
a communications service for communicating the associated stored covert advertising content for display on the display.

19. The system of claim 18, wherein said lines manager is configured to:
obtain caption information from an internet source.

20. The system of claim 18, wherein said manager is configured to:
determine whether a caption file is in a preferred file format; and
transform the caption file to generate a text format when it is determined that the caption file is not in the preferred file format.

21. An apparatus for covert advertising comprising:
a memory for storing control programs and instructions and media content; and
a processor for executing the control programs and instructions, said apparatus configured to:
convert at least one of audio, a visual product representation and a visual service representation in the video content into text;
search a database to determine if an identifier for stored advertising content is associated with the text; and
if an identifier for stored advertising content is associated with the text, request the communication of the associated stored advertising content for display.
